(19) United States
(12) Patent Application Publication
(10) Pub. No.: US 2016/0259114 A1
(43) Pub. Date: Sep. 8, 2016

(54) DISPLAY DEVICE AND PORTABLE ELECTRONIC APPARATUS

(71) Applicant: Seiko Epson Corporation, Tokyo (JP)

(72) Inventor: Hidekazu Kobayashi, Hara-mura (JP)

(21) Appl. No.: 15/047,904

(22) Filed: Feb. 19, 2016

(30) Foreign Application Priority Data
Mar. 6, 2015 (JP) 2015-044364

(51) Int. Cl. F21V 8/00

(52) U.S. Cl. CPC G02B 6/0046; G02B 6/004; G02B 6/0016

(57) ABSTRACT

A display device includes a reflective display panel and an illumination device (a front light). In the illumination device, a side surface on an opposite side of a light guide plate to a light source is a curved section, and an end surface of the curved section is a tapered surface. With respect to the light guide plate, a light absorption layer, which overlaps with an end section on the opposite side to the light source, is provided on a side of the display panel. Therefore, it is difficult for a circumstance in which light that is reflected toward the display panel in the end section is reflected by the display panel, and emitted from a second surface of the light guide plate, to occur.

### BACKGROUND

1. Technical Field

The present invention relates to a display device that is provided with an illumination device, and a portable electronic apparatus.

2. Related Art

In display devices that are provided with reflective display panels, an illumination device that is referred to as a so-called front light, is used since it is not possible to use transmitted light. In such an illumination device, light is caused to be incident from a side surface of a light guide plate, and as shown by an arrow P in FIG. 6B, illumination light is emitted toward a display panel 10 from a first surface 51 (one surface) in a thickness direction of a light guide plate 50. Further, an image is displayed as a result of the illumination light being emitted from a second surface 52 (the other surface) of the light guide plate 50 after being modulated by the display panel 10 (refer to JP-A-2013-88501). In addition, in the light guide plate 50, a light scattering section 59, which is formed from a plurality of convex sections 590 or a plurality of concave sections, is provided on at least one of the first surface 51 and the second surface 52 (the other surface).

In the illumination device 30, and the like, which are shown in FIGS. 6A and 6B, in a case in which the light guide plate 50 is a resin molded product or the like, in the light guide plate 50, with the exception of a light incidence section 55, to which light from a light source 40 is incident, a side surface 54 is a tapered surface. In this case, as shown in FIG. 6A, in light that is emitted from the second surface 52 of the light guide plate 50, there is a problem in that the intensity of the light that is emitted in a region (a region 50a that is shown by a two-dot chain line) that is separated from the light incidence section 55 is much higher than the intensity of light that is emitted from other regions. Since the integrity of an image is reduced, it is not preferable if a resulting variation in intensity is also generated in an image display region 1a.

As a result of examining the causes of the abovementioned problem, as shown in FIG. 6B, the present inventors made the novel discovery of the fact that light that travels inside the light guide plate 50 is reflected at an interface between the display panel 10 and an air layer after being reflected toward the display panel 10 at an end section 541 (a tapered surface) of the side surface 54 on an opposite side to a light source 40, and is emitted from the second surface 52 of the light guide plate 50. In particular, as shown in FIG. 6A, in a case in which the end section 541 on the opposite side is a curved section 540 that overhangs on an opposite side to the light source 40, since it is easy to collect the light that is reflected toward the display panel 10 at the end section 541 on the opposite side in the specific region 50a, the variation in intensity becomes larger.

### SUMMARY

An advantage of some aspects of the invention is to provide a display device that can, on the basis of the abovementioned discovery, suppress a reduction in the integrity of an image even in a case in which a side surface of a light guide plate that is used in an illumination device is a tapered surface, and a portable electronic apparatus that is provided with such a display device.

According to an aspect of the invention, there is provided a display device including a display panel and an illumination device, which is provided with a light guide plate that is disposed facing the display panel, and a light source that faces a side surface of the light guide plate, which emits illumination light onto the display panel from one surface in a thickness direction of the light guide plate, and which emits image light that is modulated by the display panel from the other surface in the thickness direction of the light guide plate, in which at least an end section of the side surface that is on an opposite side to the light source is a tapered surface, and at least a light absorption layer, which overlaps with the end section on the opposite side, is provided on a side of the display panel with respect to the light guide plate.

In the invention, if light that is emitted from the light source travels inside the light guide plate, and is emitted toward the display panel by being reflected by at least the end section (the tapered surface) of the side surface of the light guide plate on the opposite side to the light source, there is a concern that the light will be reflected at an interface between the display panel and an air layer, and emitted from a specific region of the light guide plate. However, in the invention, with respect to the light guide plate, the light absorption layer, which overlaps with the end section on the opposite side to the light guide plate, is provided on a side of the display panel. Therefore, even if light, which is reflected at the end section on the opposite side, is emitted toward the display panel, since the light is absorbed by the light absorption layer, it is difficult for a circumstance in which the light is reflected on the side of the display panel and emitted from the other surface of the light guide plate, to occur. For this reason, it is possible to suppress a reduction in the integrity of an image as a result of light that is reflected at the interface between the display panel and an air layer.

The invention is effective when applied to a case in which the light guide plate is a resin molded product in which a light scattering section that is formed from a plurality of convex sections or a plurality of concave sections is provided on at least one of the one surface and the other surface thereof. In this case, it is possible to manufacture the light guide plate at low cost. In this case, it is necessary provide a cut taper for cutting from a metallic mold, on the side surface of the light guide plate, but according to the invention, even if such a cut taper is provided, it is possible to suppress a reduction in the integrity of an image due to light that is reflected by the tapered surface.

The invention is effective when applied to a case in which, in a planar shape of the light guide plate, the end section on the opposite side is a curved section that overhangs on the opposite side to the light source. In a case in which the end section on the opposite side is a curved section, it is easy to collect the light that is reflected by the end section (the tapered surface) on the opposite side in a specific region, but according to the invention, even in a case in which the curved section is a tapered surface, it is possible to suppress a reduction in the integrity of an image due to light that is reflected by the tapered surface.

In the invention, it is preferable that the display panel includes a first substrate, a light-transmissive second substrate that faces the first substrate on a light guide plate side, a display layer that is provided between the first substrate and the second substrate, and a sealing layer that seals the periphery of the display layer between the first substrate and the second substrate, and that the light absorption layer is provided in at least the end section on the opposite side in a region that overlaps with the entire sealing layer. Since the region that overlaps with the sealing layer is a region that does not directly contribute to the display of an image, even if the light absorption layer is provided in a range that overlaps with the entire sealing layer, there is no obstruction to the display of an image.

In the invention, it is preferable that the first substrate is a light-transmissive substrate, and the light absorption layer is provided on a surface of the first substrate that is on an opposite side to the second substrate. In this case, it is possible to provide the light absorption layer after manufacturing the display panel, or after manufacturing the display device, and the like, and therefore, it is possible to provide the light absorption layer at a timing that is convenient in terms of the overall process.

In the invention, an aspect in which the light absorption layer is provided on any one of a surface of the first substrate on a second substrate side, a surface of the second substrate on a first substrate side, and a surface of the second substrate that is on an opposite side to the first substrate, may be adopted.

In the invention, an aspect in which the sealing layer configures the light absorption layer as a result of being configured by a light-absorbing material, may be adopted. In this case, it is not necessary provide the light absorption layer separately.

In the invention, it is possible to adopt an aspect in which the light absorption layer is provided in at least a portion in a circumferential direction that includes the end section on the opposite side.

In the invention, an aspect in which the light absorption layer is provided throughout the entire circumference along an outer edge of the light guide plate, may be adopted.

The display device in which the invention is adopted can be used in various electronic apparatuses such as a portable electronic apparatus.

### BRIEF DESCRIPTION OF THE DRAWINGS

The invention will be described with reference to the accompanying drawings, wherein like numbers reference like elements.

FIGS. 1A and 1B are explanatory diagrams that show an aspect of a display device according to Embodiment 1 of the invention.

FIG. 2 is an enlarged cross-sectional view that shows an end section on an opposite side to a light source in the display device according to Embodiment 1 of the invention.

FIG. 3 is a plan view that shows an aspect of a display device according to Embodiment 2 of the invention.

FIGS. 4A to 4D are cross-sectional views that show an aspect of a display device according to other embodiments of the invention.

FIG. 5 is an explanatory diagram of a portable electronic apparatus that is provided with a display device in which the invention is adopted.

FIGS. 6A and 6B are explanatory diagrams of a display device according to a reference example of the invention.

### DESCRIPTION OF EXEMPLARY EMBODIMENTS

Embodiments of the invention will be described with reference to the drawings. Additionally, in the drawings that are referred to in the following description, the scales are altered for each layer and each member in order to make each layer and each member have a size that is easy to understand in the drawings.

### Embodiment 1

### Configuration of Display Device

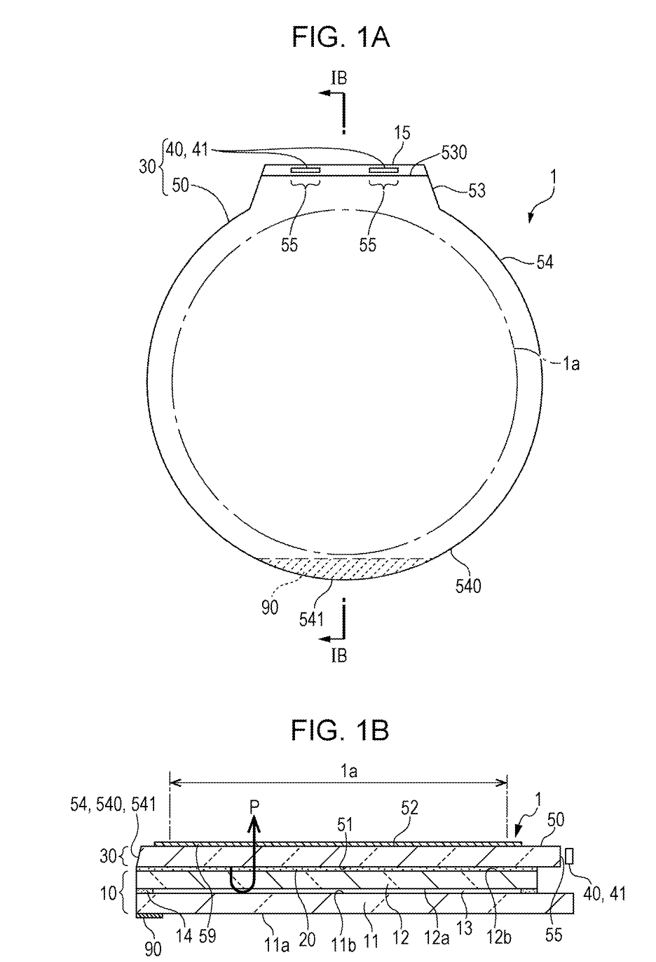

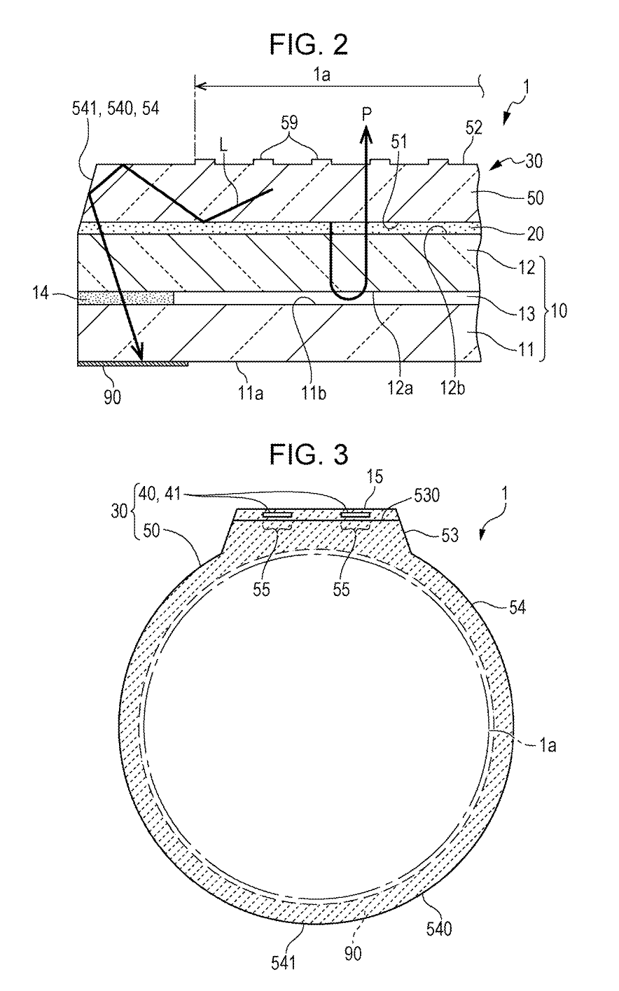

FIGS. 1A and 1B are explanatory diagrams that show an aspect of a display device according to Embodiment 1 of the invention, FIG. 1A is a plan view, and FIG. 1B is a cross-sectional view along a line IA-IA of the display device. FIG. 2 is an enlarged cross-sectional view that shows an end section on an opposite side to a light source in the display device according to Embodiment 1 of the invention.

A display device 1 that is shown in FIGS. 1A and 1B includes a display panel 10, and an illumination device 30 that is provided with a light guide plate 50, which is disposed facing the display panel 10.

In the present embodiment the display panel 10 includes a first substrate 11, which is a reflective display panel such as an electrophoretic display panel, a reflective liquid crystal display panel, a MEMS element, or a light interference element, a light-transmissive second substrate 12 that is disposed facing the first substrate 11, a display layer 13 that is provided between the first substrate 11 and the second substrate 12, and a sealing layer 14, which is a transparent layer that seals the periphery of the display layer 13 between the first substrate 11 and the second substrate 12. Electrodes (not illustrated in the drawing) that drive the display layer 13 are provided on a surface 11b that faces the second substrate 12 in the first substrate 11, and on a surface 12a that faces the first substrate 11 in the second substrate 12. In the invention, in addition to the second substrate 12, the first substrate 11 and the sealing layer 14 are light-transmissive.

In the reflective display panel 10, as shown by the arrow P in FIG. 1B, illumination light, which is incident from a side of the second substrate 12, is modulated and displayed as an image by the display layer 13 during a period of being reflected at a side of the display layer 13 and the first substrate 11, and output from the side of the second substrate 12. In the present embodiment, the display panel 10 is an electrophoretic display panel.

### Configuration of Illumination Device 30

The illumination device 30 is configured as a so-called front light, and includes a light source 40, and a light-transmissive light guide plate 50 that is provided with a light incidence section 55, which faces the light source 40, on a side surface 54. In the present embodiment, the light guide plate 50 is bonded to a surface 12b of the second substrate 12 of the display panel 10, which is on an opposite side to the first substrate 11 using a light-transmissive adhesive layer 20. The light guide plate 50 is formed from a light-transmissive resin with a refractive index of 1.5 to 1.6, and in the present embodiment, is formed from a resin molded product of polycarbonate (refractive index=1.59).

In the illumination device 30, after being incident to an inner section of the light guide plate 50 from the light incidence section 55 of the light guide plate 50, light that is emitted from the light source 40 travels inside the light guide plate 50 while being repeatedly reflected between a first surface 51 and a second surface 52, which face one another in a thickness direction of the light guide plate 50, and among the first surface 51 and the second surface 52, illumination light is emitted to the display panel 10 from the first surface 51 (one surface in the thickness direction), which is provided on the display panel 10 side. Further, an image is displayed as a result of the illumination light being incident to the inside of the light guide plate 50 from the first surface 51 of the light guide plate 50, and emitted from the second surface 52 after being modulated by the display panel 10.

A light scattering section 59 that is formed from convex sections 590 and concave sections is formed with a predetermined distribution on at least one of the first surface 51 and the second surface 52 of the light guide plate 50. In the present embodiment, the light scattering section 59 is, for example, formed from a plurality of convex sections with a radius of 60 μm, a height of 10 μm and at a pitch of 0.2 mm, and is provided on the second surface 52 of the light guide plate 50. Additionally, in FIG. 1B, only a range in which the light scattering section 59 is formed in shown, and the illustration of the convex sections that form the light scattering section 59 is omitted.

In the present embodiment, the light guide plate 50 has a substantially circular planar shape, and a portion of the circumferential direction thereof is a protruding section 53 that protrudes on an outer side in a diameter direction. Therefore, except for the protruding section 53, substantially the entirety of the light guide plate 50 in the circumferential direction is a curved section 540 that overhangs on the outer side in the diameter direction. In the present embodiment, the thickness of the light guide plate 50 is 0.4 mm, and the diameter thereof is 32 mm.

A tip end section 530 of the protruding section 53 has a linear shape, and among the side surface 54 of the light guide plate 50, the light incidence section 55 is provided on the tip end section 530 of the protruding section 53. In the present embodiment, regarding the light incidence section 55, the light incidence section 55 is provided in two adjacent locations on the tip end section 530 of the protruding section 53. In addition, the light source 40 is formed from two light-emitting elements 41 that respectively face the two light incidence sections 55. A maximum width dimension of the light guide plate 50 in a width direction that is orthogonal to a direction which the light source 40 and the light incidence sections 55 face, is considerably larger than a width dimension of a range over which the light incidence sections 55 are provided.

In the same manner as the light guide plate 50, the display panel 10 has a substantially circular planar shape, and includes a protruding section 15, which overlaps with the protruding section 53 of the light guide plate 50. Therefore, in the display panel 10, the sealing layer 14 is formed in an annular shape along the side surface 54 of the light guide plate 50. However, the planar shape of the display panel 10 is not limited to a circular shape, and may be a rectangle.

In either case, a portion of a region in which the display panel 10 and the light guide plate 50 overlap, is used as an image display region 1a. In the present embodiment, the image display region 1a is formed on an inner side of the sealing layer 14 of the display panel 10, and is configured as a circular region with an external diameter that is slightly smaller than that of the light guide plate 50.

The light-emitting elements 41 that are used as the light source 40 are light-emitting diodes that emit white light, and in the corresponding light-emitting diodes, white light is created as a result of a yellow fluorescent substance being excited by blue light. Accordingly, in a practical sense, the light-emitting elements 41 function as substantially elliptical surface light sources. The light-emitting elements 41 are disposed so that the minor axes thereof face a thickness direction of the light guide plate 50, and the major axes thereof face an extension direction of the side surface 54 (the light incidence section 55) in the light guide plate 50.

### Configuration of Side Surface 54

In the display device 1 of the present embodiment, the light guide plate 50 is formed from a resin molded product, and it is possible to form the light scattering section 59 simultaneously. For this reason, it is possible to reduce the manufacturing cost of the light guide plate 50.

In this instance, when the light guide plate 50 is formed as a resin, a cut taper for cutting from a metallic mold is provided on the side surface 54 of the light guide plate 50. Therefore, a taper of approximately 5° is formed on the side surface 54 of the light guide plate 50. Additionally, among the side surface 54 of the light guide plate 50, since the light incidence section 55 is formed on a surface that is perpendicular to the first surface 51 and the second surface 52, with the exception of the light incidence section 55, a taper is formed over substantially the entirety of the side surface 54 of the light guide plate 50. In the present embodiment, the light guide plate 50 is disposed so that the taper of the side surface 54 faces an opposite side to the display panel 10.

### Configuration of Light Absorption Layer 90

In a display device 1 that is configured in this manner, a light absorption layer 90 is provided on a side of the display panel 10 with respect to the light guide plate 50, in at least a region of the side surface 54 that overlaps with an end section 541 on an opposite side to the light source 40 the end section on the opposite side in a region that overlaps with the entire sealing layer. More specifically, among the side of the display panel 10 with respect to the light guide plate 50, the light absorption layer 90 is provided on the first substrate 11 of the display panel 10, on a surface 11a that is on the opposite side to the second substrate 12. In addition, the light absorption layer 90 is provided in the end section 541 on the opposite side of the light guide plate 50, in a region that overlaps with the entire sealing layer 14. In the present embodiment, the light absorption layer 90 is formed in an arc shape in a predetermined angular region along the end section 541 on the opposite side of the light guide plate 50 and the sealing layer 14, and is provided in a portion in the circumferential direction that runs along the side surface 54 of the light guide plate 50.

Additionally, the light absorption layer 90 does not have an effect on the display of an image since the light absorption layer 90 is provided in the first substrate 11 on the surface 11a on the opposite side to the second substrate 12. Accordingly, the light absorption layer 90 may be formed up to a region that overlaps with the image display region 1a, but is formed further on an outer side than the image display region 1a.

For example, it is possible to use a black coating film, black tape or the like as such a light absorption layer 90, and in either case, the light absorption layer 90 is provided so that there is not an air layer between the first substrate 11 and the light absorption layer 90.

### Main Effects of Present Embodiment

In the manner described above, in the display device 1 of the present embodiment, when light that is emitted from the light source 40 enters the inside of the light guide plate 50 from the light incidence section 55, among the side surface 54 of the light guide plate 50, when light L that travels inside the light guide plate 50 is reflected by at least the end section 541 (the tapered surface) on the opposite side to the light source 40, the light L is emitted toward the display panel 10. However, in the present embodiment, since the light absorption layer 90, which overlaps with the end section 541 on the opposite side of the light guide plate 50, is provided on the side of the display panel 10 with respect to the light guide plate 50, even if the light L that is reflected by the end section 541 on the opposite side is emitted toward the display panel 10, the corresponding light is absorbed by the light absorption layer 90. Therefore, it is difficult for a circumstance in which light that is reflected at the interface between the first substrate 11 of the display panel 10 and an air layer, is emitted from the second surface 52 of the light guide plate 50, to occur. For this reason, it is possible to suppress a reduction in the integrity of an image as a result of light that is reflected at the interface between the first substrate 11 of the display panel 10 and an air layer.

In particular, in the present embodiment, since the end section 541 on the opposite side is the curved section 540, which overhangs on the opposite side to the light source 40, it is easy to collect the light that is reflected by the end section 541 (the tapered surface) on the opposite side in a specific region, but according to the present embodiment, even in a case in which the curved section 540 is a tapered surface, it is possible to suppress a reduction in the integrity of an image due to light that is reflected by the tapered surface.

In addition, in the present embodiment, since the light absorption layer 90 is provided in a region that overlaps with the entire sealing layer 14, it is difficult for a circumstance in which light that is reflected by the end section 541 on the opposite side of the light guide plate 50, is reflected at the interface between the display panel 10 and an air layer, and emitted from the second surface 52 of the light guide plate 50, to occur.

In addition, in the present embodiment, the light absorption layer 90 is provided on the surface 11a of the first substrate 11, which is on the opposite side to the second substrate 12. Therefore, it is possible to provide the light absorption layer 90 after manufacturing the display panel 10, or after manufacturing the display device 1, and the like, and therefore, it is possible to provide the light absorption layer at a timing that is convenient in terms of the overall process. In addition, in a case in which the light absorption layer 90 is provided on the surface 11a of the first substrate 11, which is on the opposite side to the second substrate 12, since the light absorption layer 90 does not obstruct the emission of image light, it is possible to form the light absorption layer 90 over a wide range.

### Embodiment 2

FIG. 3 is a plan view that shows an aspect of a display device according to Embodiment 2 of the invention. Additionally, since the basic configuration of the present embodiment is the same as that of Embodiment 1, the same reference numerals will be applied to shared portions, and description thereof will be omitted.

In Embodiment 1, the light absorption layer 90 is provided in a portion in the circumferential direction along the end section 541 on the opposite side of the light guide plate 50 and the sealing layer 14, but as shown in FIG. 3, the light absorption layer 90 may be provided throughout the entire circumference along the side surface 54 (the outer edge) of the light guide plate 50.

### Other Embodiments

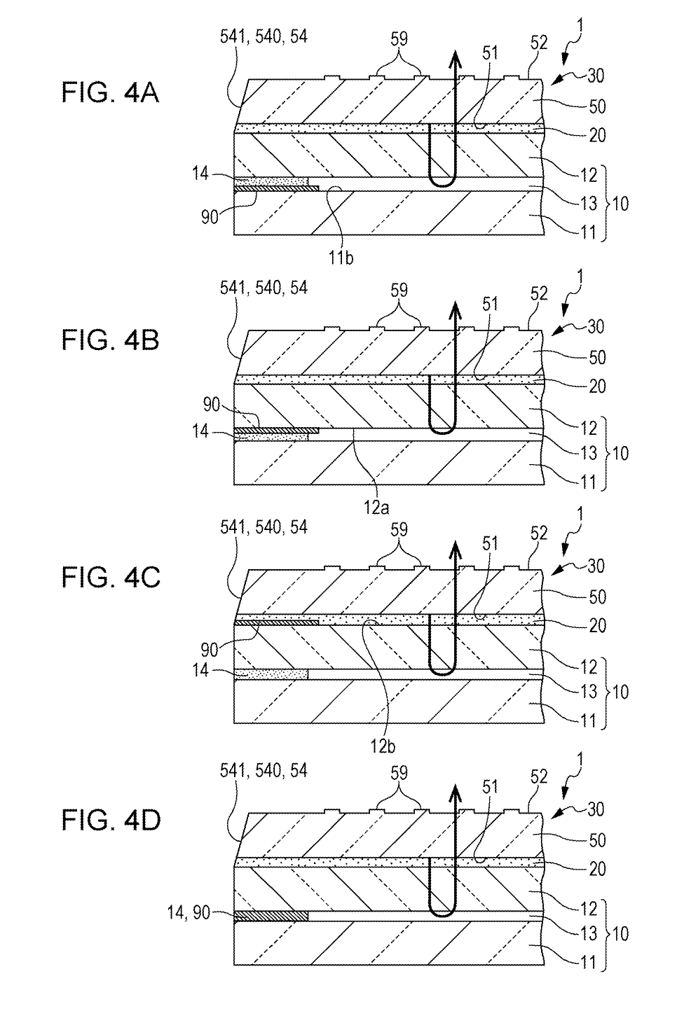

FIGS. 4A to 4D are cross-sectional views that show an aspect of a display device according to other embodiments of the invention, FIG. 4A is a cross-sectional view of a First Modification Example, FIG. 4B is a cross-sectional view of a Second Modification Example, FIG. 4C is a cross-sectional view of a Third Modification Example, and FIG. 4D is a cross-sectional view of a Fourth Modification Example.

In Embodiments 1 and 2 above, the light absorption layer 90 is provided on the surface 11a of the first substrate 11, which is on the opposite side to the second substrate 12, but as shown in FIGS. 4A to 4D, the light absorption layer 90 may be provided in other positions as long as the light absorption layer 90 is provided on the side of the display panel 10 with respect to the light guide plate 50.

For example, as shown in FIG. 4A, the light absorption layer 90 may be provided on the surface 11b of a second substrate 12 side of the first substrate 11. In addition, as shown in FIG. 4B, the light absorption layer 90 may be provided on the surface 12a of a first substrate 11 side of the second substrate 12. In addition, as shown in FIG. 4C, the light absorption layer 90 may be provided on the surface 12b of the second substrate 12, which is on an opposite side to the first substrate 11.

In addition, as shown in FIG. 4D, the light absorption layer 90 may be configured by the sealing layer 14 itself as a result of configuring the sealing layer 14 using a light-absorbing material. According to such a configuration, it is not necessary provide the light absorption layer 90 separately.

Additionally, although illustration thereof has been omitted, the light absorption layer 90 may be configured on the first surface 51 of the light guide plate 50.

### Other Embodiments

In the present embodiment, the light guide plate 50 has a substantially circular planar shape, but the invention may be applied to a case of using a light guide plate 50 in which the light guide plate 50 is elliptical or ellipsoidal. Furthermore, the invention may be applied to a case of using a light guide plate 50 that has an overall rectangular shape. In addition, in the present embodiment, a reflective display panel is used as the display panel 10, but the display panel 10 may be a photo frame that stores and exhibits photographs or the like, a sign that displays advertising or the like, or an apparatus that is used in an automobile or the like.

### Configuration Example of Electronic Apparatus

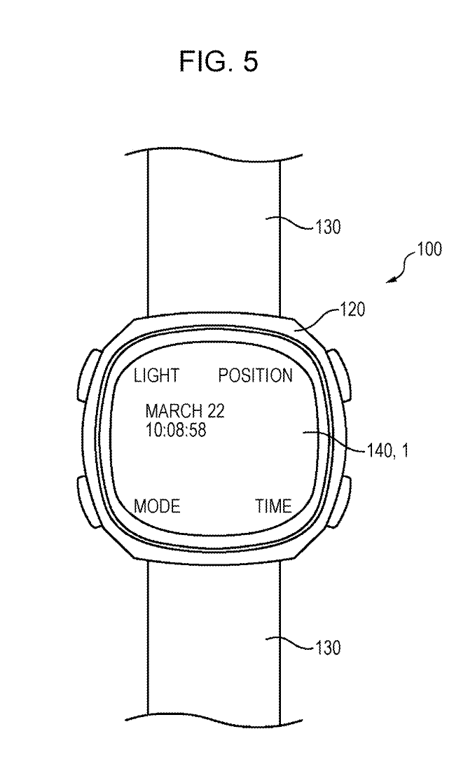

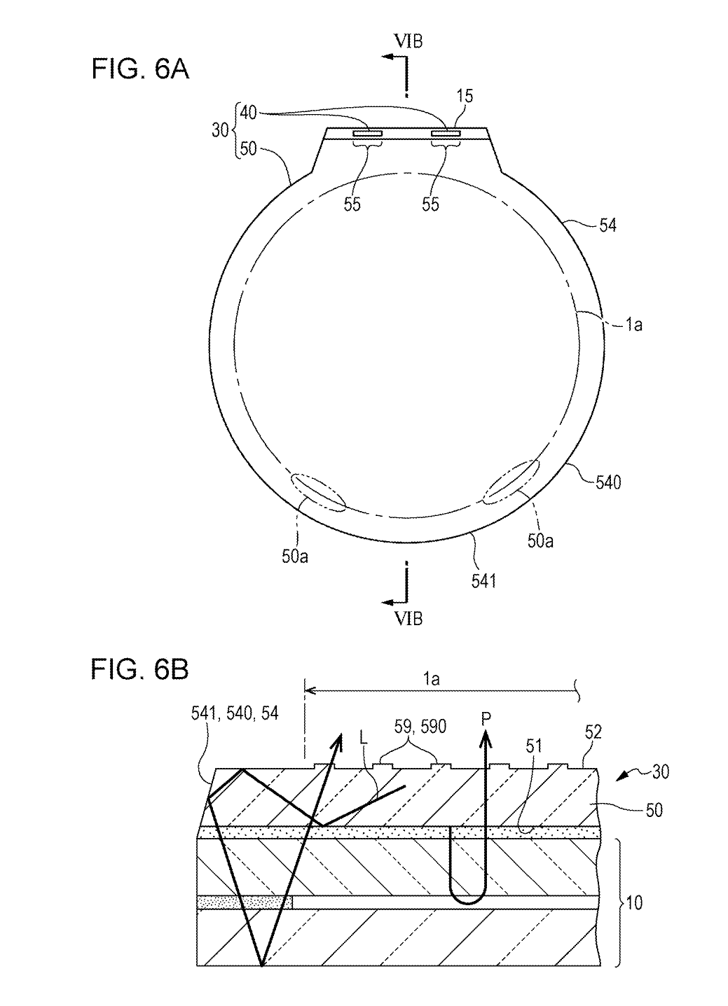

FIG. 5 is an explanatory diagram that shows an aspect of a portable electronic apparatus 100 that is provided with the display device 1 in which the invention is adopted. The portable electronic apparatus 100 that is shown in FIG. 5 is a wrist-worn electronic apparatus, and is provided with a main body section 120 and a band section 130. In addition to a clock function, the main body section 120 is equipped with a GPS (Global Positioning System) function, which is a type of satellite positioning system. A display section 140 is configured in the center of the main body section 120, the display device 1 that was described with reference to FIGS. 1A and 1B is used in such a display section 140, and a current date and time, positional information, and the like, are displayed.

Furthermore, in addition to the portable electronic apparatus 100 that is shown in FIG. 5, the display device 1 to which the invention is applied may be used as a display device of a mobile telephone, a personal digital assistant (PDA), a camera finder, electronic paper or the like.

The entire disclosure of Japanese Patent Application No. 2015-044364, filed Mar. 6, 2015 is expressly incorporated by reference herein.

What is claimed is:

1. A display device comprising:
a display panel; and
an illumination device, which is provided with a light guide plate that is disposed facing the display panel, and a light source that faces a side surface of the light guide plate, which emits illumination light onto the display panel from one surface in a thickness direction of the light guide plate, and which emits image light that is modulated by the display panel from the other surface in the thickness direction of the light guide plate,
wherein at least an end section of the side surface that is on an opposite side to the light source is a tapered surface, and
wherein at least a light absorption layer, which overlaps with the end section on the opposite side, is provided on a side of the display panel with respect to the light guide plate.

2. The display device according to claim 1,
wherein the light guide plate is a resin molded product in which a light scattering section that is formed from a plurality of convex sections or a plurality of concave sections is provided on at least one of the one surface and the other surface thereof.

3. The display device according to claim 1,
wherein in a planar shape of the light guide plate, the end section on the opposite side is a curved section that overhangs on the opposite side to the light source.

4. The display device according to claim 1,
wherein the display panel includes a first substrate, a light-transmissive second substrate that faces the first substrate on a light guide plate side, a display layer that is provided between the first substrate and the second substrate, and a sealing layer that seals the periphery of the display layer between the first substrate and the second substrate, and
wherein, the light absorption layer is provided in at least the end section on the opposite side in a region that overlaps with the entire sealing layer.

5. The display device according to claim 4,
wherein the first substrate is a light-transmissive substrate, and
wherein the light absorption layer is provided on a surface of the first substrate that is on an opposite side to the second substrate.

6. The display device according to claim 4,
wherein the light absorption layer is provided on any one of a surface of the first substrate on a second substrate side, a surface of the second substrate on a first substrate side, and a surface of the second substrate that is on an opposite side to the first substrate.

7. The display device according to claim 4,
wherein the sealing layer configures the light absorption layer as a result of being configured by a light-absorbing material.

8. The display device according to claim 1,
wherein the light absorption layer is provided in at least a portion in a circumferential direction that includes the end section on the opposite side.

9. The display device according to claim 1,
wherein the light absorption layer is provided throughout the entire circumference along an outer edge of the light guide plate.

10. A portable electronic apparatus comprising:
the display device according to claim 1.

11. A portable electronic apparatus comprising:
the display device according to claim 2.

12. A portable electronic apparatus comprising:
the display device according to claim 3.

13. A portable electronic apparatus comprising:
the display device according to claim 4.

14. A portable electronic apparatus comprising:
the display device according to claim 5.

15. A portable electronic apparatus comprising:
the display device according to claim 6.

16. A portable electronic apparatus comprising:
the display device according to claim 7.

17. A portable electronic apparatus comprising:
the display device according to claim 8.

18. A portable electronic apparatus comprising:
the display device according to claim 9.
